(19) United States
(12) Patent Application Publication
(10) Pub. No.: US 2025/0084711 A1
(43) Pub. Date: Mar. 13, 2025

(54) PROTECTIVE BARRIER COATING TO IMPROVE BOND INTEGRITY IN DOWNHOLE EXPOSURES

(71) Applicant: Halliburton Energy Services, Inc., Houston, TX (US)

(72) Inventors: Charles Timothy Smith, Edgewood, TX (US); Chad William Glaesman, McKinney, TX (US)

(73) Assignee: Halliburton Energy Services, Inc., Houston, TX (US)

(21) Appl. No.: 18/953,365

(22) Filed: Nov. 20, 2024

Related U.S. Application Data
(63) Continuation of application No. 16/646,510, filed on Mar. 11, 2020, now abandoned.

(51) Int. Cl. E21B 17/10; C09D 201/00; E21B 43/10

(52) U.S. Cl. CPC E21B 17/1085; C09D 201/00; E21B 43/105

(57) ABSTRACT

A system for protecting a bond line may comprise a downhole tool and a rubber material bonded to the downhole tool to form the bond line. The downhole tool may further include a barrier configured to be applied to the rubber material and the ridged substrate to encapsulate the bond line. A method for protecting a bond line may comprise attaching at least a portion of a rubber to a downhole tool to form the bond line and applying a barrier to the rubber material and the downhole tool to encapsulate the bond line.

### CROSS REFERENCE TO RELATED APPLICATIONS

This Application is a Continuation of U.S. patent application Ser. No. 16/646,510, filed Mar. 11, 2020, which is a national stage application, filed under 35 U.S.C. 371, of International Patent Application No. PCT/US2019/026820, filed Apr. 10, 2019, which is incorporated by reference in its entirety

### BACKGROUND

During wellbore operations, any number of downhole tools may be used for various operations to perform specific functions during those operations. In many examples, downhole tools may include rubber pieces, device, and/or the sort that are bonded to a ridged substrate, generally metal, on the downhole tool. During operations, rubber implements may play a vital role in allowing a downhole tool to function properly. Failure of the bond between the rubber material and ridged substrate may be detrimental to the functionality of the downhole tool.

Many bonding systems for bonding rubber material to a rigid substrate that are commercially available are susceptible to attack through hydrolytic reactions. This attack will weaken the bond strength of an engineered composite and lead to premature failure of the bonded system. Environmental factors like temperature, static pressure, and pH can accelerate the attack of the bonding mechanism at the interface between the elastomer and rigid substrate.

Current methods and systems may not be suitable to prevent the degradation of a bond in an aqueous solution. Degradation of the bond between rubber material and a ridged substrate may lead to failure of the bond. Failure of the bond may lead to downhole tools failing to function properly and may be detrimental to downhole operations.

### BRIEF DESCRIPTION OF THE DRAWINGS

These drawings illustrate certain aspects of some of the embodiments of the present disclosure, and should not be used to limit or define the disclosure;

FIG. 1 is a schematic diagram of an example of an expandable liner hanger disposed in a wellbore;

FIG. 2 is a diagram of an example of a barrier disposed on the expandable liner hanger; and

FIG. 3 is a diagram of another example of a barrier disposed on the expandable liner hanger.

### DETAILED DESCRIPTION

This disclosure presents systems and methods that may be performed in conjunction with downhole tools and, specifically, for employing a barrier to prevent aqueous solutions from degrading a bond line between rubber material and a metal matrix.

In examples, a barrier may be applied that may use a variety of different polymeric materials to prevent fluid migration along the bonding interface between a rubber material and a rigid substrate by diffusion through the bonded material. Without limitation, a barrier may isolate the fluid from attacking the bonding chemistry. Therefore, bond stability between the two materials may improve the performance and reliability of down hole equipment that relies on the bond strength integrity for functionality. Bonded sealing components that are subject to API 19AC elevated validation requirements may benefit from a more robust environmental resistance of the bonding strength through the elimination of the exposure.

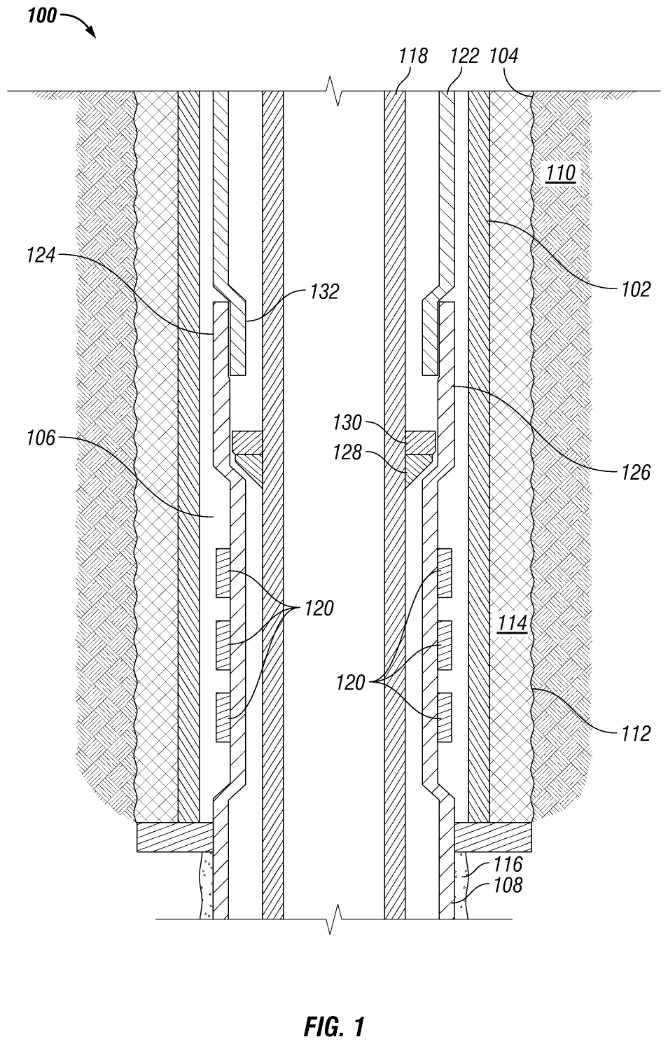

FIG. 1 illustrates an example of an expandable liner hanger system 100. In expandable liner hanger system 100, a casing string 102 has been installed and cemented within a wellbore 104. An expandable liner hanger 108 may be hung, extending downhole from a lower end of casing string 102. An annulus 106 may be created between casing string 102 and expandable liner hanger 108. In examples, an expandable liner hanger 108 may support additional wellbore casing, operational tubulars or tubing strings, completion strings, downhole tools, etc., for positioning at greater depths.

As used herein, the terms “liner,” “casing,” and “tubular” are used generally to describe tubular wellbore items, used for various purposes in wellbore operations. Liners, casings, and tubulars may be made from various materials (metal, plastic, composite, etc.), may be expanded or unexpanded as part of an installation procedure, and may be segmented or continuous. It is not necessary for a liner or casing to be cemented into position. Any type of liner, casing, or tubular may be used in keeping with the principles of the present disclosure.

As illustrated, wellbore 104 may be drilled through earth formation 110. Casing string 102 may then be placed in an upper portion 112 of wellbore 104 and may be held in place by cement 114 which may be injected between casing string 102 and upper portion 112 of wellbore 104. Below casing string 102, a lower portion 116 of wellbore 104 may be drilled through casing string 102. Lower portion 116 may have a smaller diameter than the upper portion 112. A length of expandable liner hanger 108 is shown positioned within lower portion 116. Expandable liner hanger 108 may be used to line or case lower portion 116 and/or to drill lower portion 116. In examples, cement 114 may be placed between expandable liner hanger 108 and lower portion 116 of wellbore 104. Expandable liner hanger 108 may be installed in wellbore 104 by means of a work string 118. Without limitation, work string 118 may include a releasable collet, not shown, by which it can support and rotate expandable liner hanger 108 as it is placed in wellbore 104.

Attached to expandable liner hanger 108 may be any number of annular seals 120. While three annular seals 120 are depicted for illustrative purposes, any number of annular seals 120 may be used. In examples, a polished bore receptacle, or tie back receptacle 122 may be coupled to the upper end of expandable liner hanger 108. Without limitation, the polished bore receptacle 122 may be coupled to expandable liner hanger 108 by a threaded joint 124. The inner bore of the polished bore receptacle 122 may be smooth and machined to close tolerance to permit work strings 118, production tubing, etc. to be connected to expandable liner hanger 108 in a fluid-tight and pressure-tight manner. For instance, a work string 118 may be connected by means of the polished bore receptacle 122 and used to pump fracturing fluid at high pressure down to the lower portion 116 of wellbore 104 without exposing casing string 102 to the fracturing pressure.

In examples, an outer diameter of expandable liner hanger 108 may be as large as possible while being able to lower expandable liner hanger 108 through casing string 102. Without limitation, the outer diameter of the polished bore receptacle 122 and expandable liner hanger 108 may be about the same as the diameter of expandable liner hanger 108. In run-in operations, the outer diameter of expandable liner hanger 108 may be defined by the outer diameter of annular seals 120. In the run-in operation, a body or mandrel 126 of expandable liner hanger 108 has an outer diameter reduced by about the thickness of annular seals 120 so that the outer diameter of annular seals 120 is about the same as the outer diameter of expandable liner hanger 108 and tie back receptacle 122.

In examples, first expansion cone 128 and second expansion cones 130 may be carried on the work string 118 just above the reduced diameter of mandrel 126 of expandable liner hanger 108. Fluid pressure applied between work string 118 and expandable liner hanger 108 may be used to drive first expansion cone 128 and second expansion cone 130 downward through expandable liner hanger 108 to expand mandrel 126 to an outer diameter at which annular seals 120 are forced into sealing and supporting contact with casing string 102. First expansion cone 128 may be a solid, or fixed diameter, cone having a fixed outer diameter smaller than the inner diameter 132 of threaded joint 124. In run-in operations, second expansion cone 130 may have an outer diameter greater than first expansion cone 128 and a greater than inner diameter 132 of threaded joint 124. In examples, second expansion cone 130 may be collapsible, that is, may be reduced in diameter smaller than inner diameter 132 of threaded joint 124 when second expansion cone 130 may be withdrawn from the expandable liner hanger 108. Without limitations, second expansion cone 130 may be referred to as a collapsible expansion cone. After expandable liner hanger 108 is expanded, first expansion cone 128 and second expansion cone 130 may be withdrawn from expandable liner hanger 108, through the polished bore receptacle 122 and out of wellbore 104 with work string 118.

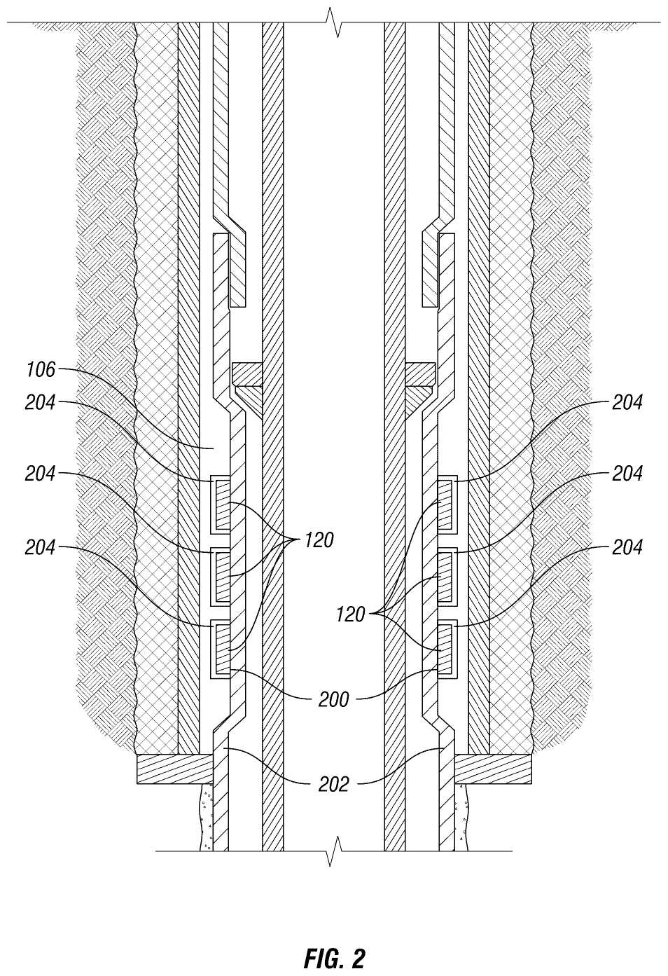

Typical annular seals 120 are made of elastomeric elements (e.g., rubber) which as discussed above may be susceptible to degradation as a result of exposure to the high temperatures, high pressures downhole, and/or aqueous solutions. Specifically, aqueous solutions may diffuse to the bond line 200 between annular seals 120 and metal substrate 202, referring to FIG. 2. Without limitation the aqueous solution may degrade the bond between annular seals 120 and metal substrate 202. Degradation of the bond may be from hydrolysis of the bond chemistry, Extraction of key components of the bond, interference with Van der Waals forces for ionic bonding, and/or the like. In examples, annular seals 120 may be exposed to aqueous solutions within annulus 106. While, annular seals 120 are specifically discussed above, it should be noted that the systems and methods described may be used for any rubber material to metal bond interface that may be disposed within an aqueous solution. Without limitations, the methods and systems described within this disclosure may be used for and materials that may be adhered to a metal substrate.

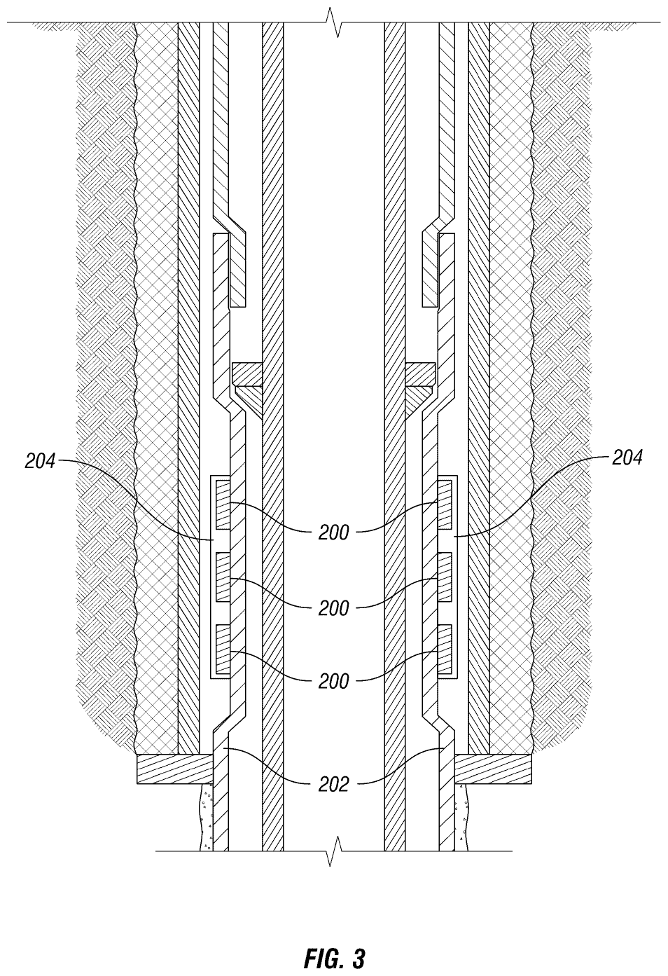

To prevent the degradation of bond line 200 a barrier 204 may be applied to prevent and/or reduce exposure of bond line 200 to an aqueous solution. As illustrated in FIG. 2, barrier 204 may be applied to a specific area where barrier 204 may encapsulate bond line 200. Additionally, as illustrated in FIG. 3, barrier 204 may be applied to encapsulate one or more bond lines 200.

Generally, barrier 204 may be any suitable polymeric material to prevent fluid migration along bond line 200 between the rubber material (e.g., annular seals 120) and metal substrate 202 by diffusion through the bonded materials. This polymeric coating may be applied after manufacture of the composite product and may create a barrier 204 to isolate the fluid from attacking the bonding chemistry along bond line 200. Without limitations, hydrophobic and/or impermeable coatings that may be applied to a finished component forming a bond line 200 through spray, roll, brush, dripping, or chemical vapor deposition (CVD) processes. A CVD process may be performed with two volatile chemicals that react in a vapor phase or at the surface of the substrate with the final product being deposited as a coating. Additionally, barrier 204 may be applied to a mold, which may allow barrier 204 to encapsulate bond line 200 during a manufacturing process. In examples, utilizing reactive chemistries that may form barrier 204 may be dicyclopentadiene (DCPD), epoxy, polyester, urethane, elastomer latex, acrylate, cyanoacrylate, or urethane acrylate.

In other examples, barrier 204 may be a hot melt or a solvent deposition process may be used to deposit materials such as acrylic melts, solvated copolymers of ethylene and propylene (EP), solvated copolymers of ethylene, propylene, and a diene monomer (EPDM), poly(methyl methacrylate (PMMA), polycarbonate, polyimide, polystyrene, polyester (e.g., polyester films such as biaxially oriented polyethylene terephthalate (BoPet films)), Fluoroplastics (e.g., terpolymers of tetrafluroethylene, hexfluropropylene, and vinylidene fluoride (THV), fluorinated ethylene propylene (FEP), polyvinylidene fluoride (PVDF), and modified ethylene-tetrafluoroethylene)), and/or the like as barrier 204. It should be noted that a hot melt process is performed with thermoplastic types of materials that may process in a melt phase. Furthermore, in a solvent deposition process, solvated materials may be sprayed, dipped, or brushed and when the solvent evaporates, the remaining solids create barrier 204. Without limitation, solvent materials may be solvated with volatile organic compounds (VOC) but may also be any volatile fluid.

Additionally, in examples, barrier 204 may be impermeable or hydrophobic materials, as listed above or the like, may be film wrapped and/or cold bonded to the outside of bond line 200. It should be noted that a film wrapped process may be performed through hand building or another automated process where a thin film or membrane may be applied directly to the bonded material to protect the product. A cold bonded may be a process utilizing an epoxy or acrylate type of adhesive.

It should be noted that during coating operations, barrier 204 may require additional finishing processes such as a vapor reaction, solvent product, and/or a heat product. Additionally, barrier 204 may be applied to an identified area to protect bond line 200 during the manufacture process or at a wellsite after a downhole tool has been formed and right before the rubber material and metal substrate are disposed into a wellbore.

Currently, coatings applied to downhole tools are developed to protect and/or modify the surface of the downhole tool to prevent the accumulation of surface debris, fouling, microbial attack, corrosion, and to impact surface friction. Barrier 204 may be applied to cover a bond line 200 to prevent the wicking and/or diffusion of an aqueous solution along bond line 200 and subsequently preventing the hydrolytic reactions that are known to degrade have a negative impact on bond strength along bond line 200.

Accordingly, the present disclosure generally relates to methods and systems for protecting a bond line 200 between rubber material and a metal substrate. The systems and methods may include any of the various features of the systems and methods disclosed herein, including one or more of the following statements.

Statement 1. A system for protecting a bond line may comprise a downhole tool, a rubber material bonded to the downhole tool to form the bond line, and a barrier configured to be applied to the rubber material and the downhole tool to encapsulate the bond line.

Statement 2. The system of statement 1, wherein the barrier is dicyclopentadiene, epoxy, polyester, urethane, elastomer latex, acrylate, cyanoacrylate, or urethane acrylate.

Statement 3. The system of statements 1 or 2, wherein the barrier is configured to be applied by spray, roll, brush, or vapor deposition.

Statement 4. The system of statements 1-3, wherein the barrier is a hot melt.

Statement 5. The system of statements 1-4, wherein the barrier is configured to be applied in a solvent deposition process.

Statement 6. The system of statement 5, wherein the barrier is an acrylic melt, a solvated copolymer of ethylene and propylene, a solvated copolymer of ethylene, propylene, and a diene monomer, polycarbonate, polyimide, polystyrene, polyester, or a fluoroplastic.

Statement 7. The system of statements 1-5, wherein the barrier is impermeable or hydrophobic.

Statement 8. The system of statement 7, wherein the barrier is configured to be applied by a film wrapped or cold bonded to an outside of the bond line.

Statement 9. The system of statements 1-5 and 7, wherein the barrier is applied to one or more bond lines.

Statement 10. The system of statements 1-5, 7, and 9, wherein the barrier is configured to prevent degradation of the bond line.

Statement 11. A method for protecting a bond line may comprise attaching at least a portion of a rubber material to a downhole tool to form the bond line and applying a barrier to the rubber material and the downhole tool to encapsulate the bond line.

Statement 12. The method of statement 11, wherein the barrier is dicyclopentadiene, epoxy, polyester, urethane, elastomer latex, acrylate, cyanoacrylate, or urethane acrylate.

Statement 13. The method of statements 11 or 12, further comprising rolling the barrier on the bond line, spraying the barrier on the bond line, brushing the barrier on the bond line or applying the barrier using a vapor deposition to the bond line.

Statement 14. The method of statements 11-13, further comprising applying the barrier as a hot melt.

Statement 15. The method of statements 11-14, further comprising applying the barrier using a solvent deposition process.

Statement 16. The method of statement 15, wherein the barrier is an acrylic melt, a solvated copolymer of ethylene and propylene, a solvated copolymer of ethylene, propylene, and a diene monomer, polycarbonate, polyimide, polystyrene, polyester, or a fluoroplastic.

Statement 17. The method of statements 11-14 and 16, wherein the barrier is impermeable or hydrophobic.

Statement 18. The method of statement 17, further comprising wrapping the barrier to an outside of the bond line or cold bonding the barrier to the outside of the bond line.

Statement 19. The method of statements 11-14 and 17, further comprising applying the barrier to one or more bond lines.

Statement 20. The method of statements 11-14, 17, and 19, wherein the barrier is configured to prevent degradation of the bond line.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

Therefore, the present embodiments are well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A system for protecting a bond line comprising:
a downhole tool;
a rubber material bonded to a tubular substrate of the downhole tool to form a bond line at a bonding interface between the rubber material and the tubular substrate; and
a barrier configured to be applied to the rubber material and the downhole tool to encapsulate the bond line to prevent a fluid from attacking a bonding chemistry along the bond line during wellbore operations as a result of temperature, pressure, and/or aqueous solutions downhole,
wherein the barrier is applied by spray, roll, brush, dripping, hot melt, solvent deposition, or vapor deposition,
wherein the barrier is applied to a plurality of bond lines axially spaced along the tubular substrate to prevent fluid migration along the binding interface by diffusion through the bonded material, and
wherein the barrier is a single, continuous barrier configured to prevent degradation of the plurality of bond lines that are axially spaced along the tubular substrate.

2. The system of claim 1, wherein the barrier is dicyclopentadiene, epoxy, polyester, urethane, elastomer latex, acrylate, cyanoacrylate, or urethane acrylate.

3. The system of claim 1, wherein the barrier is an acrylic melt, a solvated copolymer of ethylene and propylene, a solvated copolymer of ethylene, propylene, and a diene monomer, polycarbonate, polyimide, polystyrene, polyester, or a fluoroplastic.

4. The system of claim 1, wherein the barrier is impermeable or hydrophobic.

5. The system of claim 1, wherein the barrier is configured to be applied by a film wrapped or cold bonded to an outside of the bond line.

6. The system of claim 1, wherein the barrier is applied to one or more bond lines.

7. The system of claim 1, wherein the barrier is configured to prevent degradation of the bond line.

8. A method for protecting a bond line comprising:
attaching at least a portion of a rubber material to a downhole tool to form the bond line; and
applying a barrier to the rubber material and the downhole tool to encapsulate the bond line,
wherein the barrier is applied by spray, roll, brush, dripping, hot melt, solvent deposition, or vapor deposition,
wherein the barrier is applied to a plurality of bond lines axially spaced along the tubular substrate to prevent fluid migration along the binding interface by diffusion through the bonded material, and
wherein the barrier is a single, continuous barrier configured to prevent degradation of the plurality of bond lines that are axially spaced along the tubular substrate.

9. The method of claim 8, wherein the barrier is dicyclopentadiene, epoxy, polyester, urethane, elastomer latex, acrylate, cyanoacrylate, or urethane acrylate.

10. The method of claim 8, further comprising rolling the barrier on the bond line, spraying the barrier on the bond line, brushing the barrier on the bond line or applying the barrier using a vapor deposition to the bond line.

11. The method of claim 8, wherein the barrier is an acrylic melt, a solvated copolymer of ethylene and propylene, a solvated copolymer of ethylene, propylene, and a diene monomer, polycarbonate, polyimide, polystyrene, polyester, or a fluoroplastic.

12. The method of claim 8, wherein the barrier is impermeable or hydrophobic.

13. The method of claim 8, further comprising wrapping the barrier to an outside of the bond line or cold bonding the barrier to the outside of the bond line.

14. The method of claim 8, further comprising applying the barrier to one or more bond lines.

15. The method of claim 8, wherein the barrier is configured to prevent degradation of the bond line.

16. A system comprising:
a downhole tool comprising a metal substrate;
at least one annular seal;
an interface comprising at least one bond between the metal substrate and the at least one annular seal; and
a barrier,
wherein the barrier encapsulates the interface and prevents fluid migration to the interface, and
wherein the barrier is applied at a wellsite right before the downhole tool is disposed into a wellbore.

17. The method of claim 16, wherein the barrier is applied by spray, roll, brush, dripping, hot melt, solvent deposition, or vapor deposition.

18. The method of claim 16, wherein the barrier is applied by coating requiring finishing processes comprising vapor deposition, solvent product, or heat product.

19. The method of claim 16, wherein the barrier is dicyclopentadiene, epoxy, polyester, urethane, elastomer latex, acrylate, cyanoacrylate, or urethane acrylate.

20. The method of claim 16, wherein the barrier is an acrylic melt, a solvated copolymer of ethylene and propylene, a solvated copolymer of ethylene, propylene, and a diene monomer, polycarbonate, polyimide, polystyrene, polyester, or a fluoroplastic.
